(19) United States
(12) Patent Application Publication
(10) Pub. No.: US 2026/0145011 A1
(43) Pub. Date: May 28, 2026

(54) DEMAND REGULATOR

(71) Applicant: Dräger Safety AG & Co. KGaA, Lübeck (DE)

(72) Inventor: Michael John Hilton, Newcastle upon Tyne (GB)

(21) Appl. No.: 19/122,136

(22) PCT Filed: Oct. 10, 2023
(86) PCT No.: PCT/EP2023/078060

§ 371 Date: Apr. 17, 2025

(30) Foreign Application Priority Data
Oct. 18, 2022 (EP) 22202128.9

(51) Int. Cl. A62B 9/02; B63C 11/22

(52) U.S. Cl. CPC A62B 9/022; B63C 11/2227

(57) ABSTRACT

There is disclosed a demand regulator for a breathing apparatus comprising: a diaphragm apparatus in operative connection with a valve apparatus; a diaphragm biasing spring configured to apply a biasing force to the diaphragm apparatus; and a bias adjustment apparatus configured to adjust compression or deformation of the diaphragm biasing spring so as to adjust the biasing force applied to the diaphragm apparatus. Also disclosed is a breathing mask comprising a demand regulator and a breathing apparatus comprising a demand regulator.

### CROSS-REFERENCE TO RELATED APPLICATIONS

The present application claims priority to, and is a U.S. National Phase of, International Application No. PCT/EP2023/078060, filed on Oct. 10, 2023, designating the United States of America and claiming priority to European Application No. 22202128.9, filed on Oct. 18, 2022, and this application claims priority to and the benefit of both of the above-identified applications, which are fully incorporated by reference herein in their entireties.

This disclosure relates to demand regulators for emergency breathing apparatus.

### BACKGROUND

Emergency breathing apparatus commonly comprises a demand regulator, which may also be known as a lung demand valve. The demand regulator is configured to deliver breathing gas to the user on demand when the user inhales. In order to provide breathing air without significant inhalation effort by the user, the demand regulator may require calibration to achieve the required flow rate. Such calibration of the demand regulator in production and during service may be difficult to achieve in known demand regulators.

Therefore, it will be understood that it is desirable to provide improvements to demand regulators in relation to calibration.

### SUMMARY

According to a first aspect, there is provided a demand regulator for a breathing apparatus comprising: a housing defining an internal chamber; a valve apparatus for controlling flow of breathing gas into the internal chamber; a diaphragm apparatus having a first side configured to be exposed to an ambient environment and a second side configured to be exposed to the internal chamber, the diaphragm apparatus being in operative connection with the valve apparatus; a diaphragm biasing spring configured to apply a biasing force to the diaphragm apparatus; and a bias adjustment apparatus configured to adjust compression or deformation of the diaphragm biasing spring so as to adjust the biasing force applied to the diaphragm apparatus.

The breathing apparatus may be a self-contained breathing apparatus (SCBA), but it should be understood that the demand regulator may also be applicable to other types of breathing apparatus, such as self-contained underwater breathing apparatus (SCUBA) and emergency escape breathing apparatus.

The diaphragm apparatus may be in operative connection with the valve apparatus such that movement of the diaphragm apparatus controls the flow of breathing gas.

The diaphragm apparatus may comprise a resiliently deformable material. The diaphragm apparatus may comprise a substantially rigid material. The substantially rigid material may be configured to provide a contact point between the valve apparatus and the diaphragm apparatus. The diaphragm apparatus may consist of a single component or may comprise a plurality of layers or components.

Reducing the biasing force may increase the pressure differential required across the diaphragm apparatus to move the diaphragm apparatus. Increasing the biasing force may reduce the pressure differential required across the diaphragm apparatus to move the diaphragm apparatus.

The valve apparatus may comprise a valve actuator for actuating the valve apparatus. The valve actuator may be in contact with, or connected to, the diaphragm apparatus such that movement of the diaphragm actuates the valve actuator.

The diaphragm apparatus may be configured to move towards the internal chamber in response to a pressure reduction within the internal chamber. The diaphragm apparatus may be configured to move towards the internal chamber in response to a user inhaling and thereby reducing the pressure in the internal chamber.

The valve apparatus may be moveable between a fully open position providing maximum flow and a fully closed position providing minimum flow or no flow. The valve apparatus may be continuously moveable between the fully open and fully closed positions so as to meter the flow of breathing gas. The valve actuator may control the position of the valve apparatus.

The valve apparatus, or the valve actuator, may be configured such that movement of the diaphragm apparatus towards the internal chamber moves the valve towards an open position. The valve apparatus, or the valve actuator, may be configured such that movement of the diaphragm apparatus away from the internal chamber moves the valve apparatus towards a closed position.

The diaphragm apparatus may comprise a substantially impermeable membrane. The diaphragm apparatus may be configured to be deformable by a pressure difference between the first and second sides. The diaphragm apparatus may be sealed against the demand regulator about its perimeter. The diaphragm apparatus may be removable.

The diaphragm biasing spring may be configured to apply the biasing force on the diaphragm towards the internal chamber.

The diaphragm biasing spring may be configured to apply a pushing force to the diaphragm apparatus. The diaphragm biasing spring may be configured to apply a pulling force to the diaphragm apparatus.

The diaphragm biasing spring may be arranged to contact the diaphragm apparatus and contact a spring seat of the demand regulator so as to be compressed or deformed between the diaphragm apparatus and the spring seat to apply the biasing force.

The bias adjustment apparatus may be configured to adjust a spacing between the spring seat and the diaphragm apparatus so as to adjust the compression or deformation of the diaphragm biasing spring.

The spring seat may be moveable so as adjust the spacing between the spring seat and the diaphragm apparatus.

If the diaphragm biasing spring is configured to apply a pushing force to the diaphragm apparatus, then reducing the spacing between the spring seat and the diaphragm apparatus may increase the biasing force. If the diaphragm biasing spring is configured to apply a pulling force to the diaphragm apparatus, then increasing the spacing between the spring seat and the diaphragm apparatus may increase the biasing force.

The spring seat may be provided on a spring seat cap configured to substantially overlay the first side of the diaphragm apparatus, optionally wherein the spring seat cap comprises one or more apertures therethrough.

The spring seat cap may comprise a helical thread and the demand regulator or the diaphragm cap may further comprise a corresponding thread, the threads being configured to adjust a position of the spring seat cap relative to the diaphragm apparatus so as to adjust the spacing between the spring seat and the diaphragm apparatus.

Rotating the spring seat cap may adjust the spacing between the spring seat and the and the diaphragm apparatus. Clockwise rotation of the spring seat cap may decrease the spacing. Anti-clockwise rotation of the spring seat cap may increase the spacing.

Adjusting the spacing and the biasing force may adjust the resting position of the diaphragm apparatus, which may in turn, adjust a resting position or balance of the valve apparatus. Adjusting the resting position of the valve apparatus may adjust a minimum flow rate of the valve apparatus.

The diaphragm biasing spring may be a helical spring. The spring seat cap may substantially circular in plan view.

The bias adjustment apparatus may further comprise a locking feature configured to lock the bias adjustment apparatus so as to prevent adjustment of the spacing between the spring seat and the diaphragm apparatus.

The demand regulator may further comprise a diaphragm cap configured to substantially overlay the diaphragm apparatus. The diaphragm cap may be configured to secure the diaphragm between the diaphragm cap and the housing.

The diaphragm apparatus may comprise a peripheral sealing bead. The housing may comprise a first sealing seat and the diaphragm cap may comprise a second sealing seat. The diaphragm cap may be securable to the housing so as to compress or secure the sealing bead of the diaphragm apparatus between the first and second sealing seats.

The diaphragm cap may comprise the spring seat cap. The relative position of the spring seat cap and the diaphragm cap may be adjustable.

The demand regulator may further comprise a removable dust shield configured to overlay the diaphragm apparatus so as to protect the first side of the diaphragm apparatus. The removable dust shield may comprise one or more apertures for permitting fluid communication between the ambient environment and the first side of the diaphragm apparatus.

According to a second aspect, there is provided a breathing mask for a breathing apparatus comprising the demand regulator according to the first aspect.

According to a third aspect, there is provided a breathing apparatus comprising the demand regulator of the first aspect or the breathing mask of the second aspect.

According to a fourth aspect, there is provided a demand regulator for a breathing apparatus comprising: a diaphragm apparatus in operative connection with a valve apparatus; a diaphragm biasing spring configured to apply a biasing force to the diaphragm apparatus; and a bias adjustment apparatus configured to adjust compression or deformation of the diaphragm biasing spring so as to adjust the biasing force applied to the diaphragm apparatus.

Any aspect may comprise any combination of the features and/or limitations referred to with respect to any of the other aspects described above, except combinations of such features that are mutually exclusive.

### BRIEF DESCRIPTION OF THE DRAWINGS

Embodiments of the invention will now be described, by way of example, with reference to the accompanying drawings, in which:

FIG. 1 schematically shows a breathing apparatus according to an example arrangement comprising a breathing mask and a demand regulator;

FIG. 2 schematically shows a breathing mask according to an example arrangement comprising a demand regulator; and

FIG. 3 schematically shows a cross-sectional view of a demand regulator according to an example arrangement.

Like features of the Figures are shown with the same reference numbers.

### DETAILED DESCRIPTION OF THE DRAWINGS

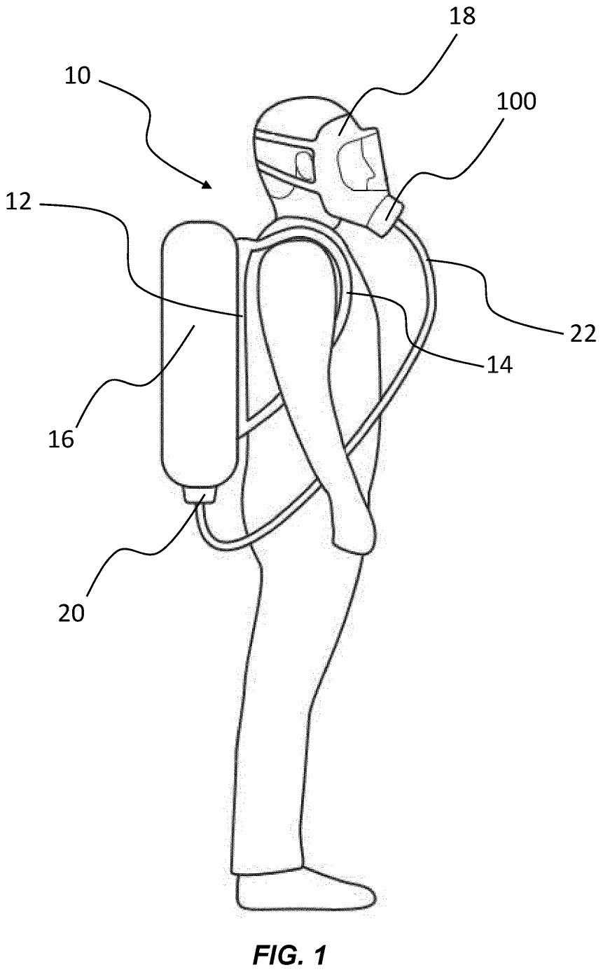

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a breathing mask 18, a demand regulator 100 connectable to the breathing mask, and a pneumatics system 20 for delivering breathing gas from the cylinder 16 via a hose or flexible conduit 22 to the demand regulator 100, to thereby deliver breathing gas to a user wearing the mask 18 on demand. The breathing apparatus 10 may further comprise other components or systems which are not shown, including but not limited to an electrical system, a monitoring system, and a communications system.

In this illustrated arrangement, the breathing apparatus is a self-contained breathing apparatus (SCBA) but it should be understood that the demand regulator 100 may also be compatible with and applicable to other types of breathing apparatus, such as self-contained underwater breathing apparatus (SCUBA) and emergency escape breathing apparatus.

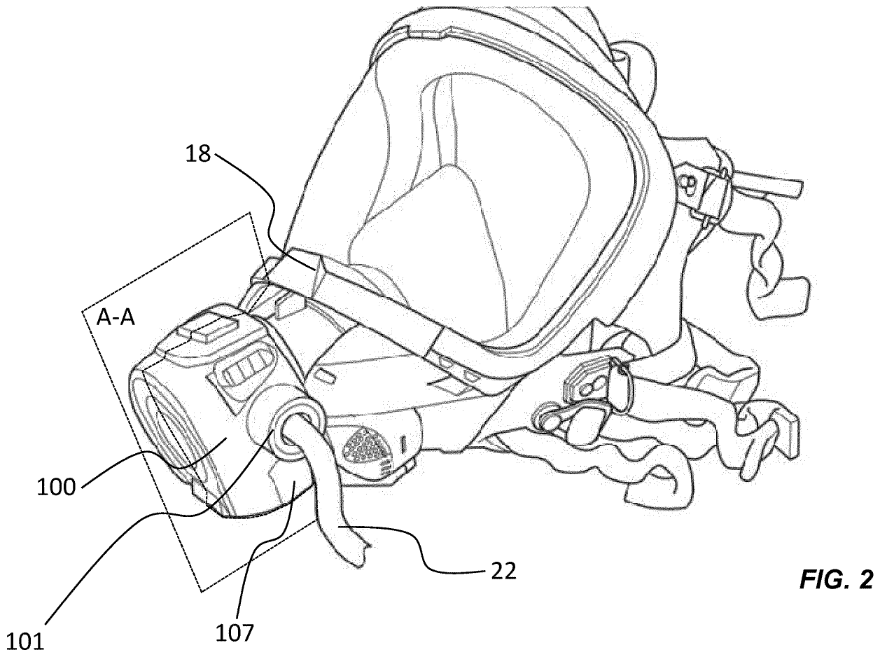

FIG. 2 shows a breathing mask 18 comprising a demand regulator 100. As shown in more detail in this figure a hose 22 of the pneumatics system 20 is connected to an inlet 101 of the demand regulator 100 to provide breathing gas from the cylinder 16. The pneumatics system 20 may comprise a first-stage pressure reducer which reduces the pressure of the breathing air from the cylinder 16 which may be stored at several hundred bar, to an intermediate pressure for provision to the demand regulator 100 via the hose 22. The intermediate pressure may be too high for the gas to be provided directly to the user to breathe. As will be described in more detail below, the demand regulator 100 may further comprise a second-stage pressure reducer which further reduces the pressure of the breathing air to a suitable pressure for delivery to the user to breathe. In other arrangements, more than two or fewer than two pressure reducers may be provided.

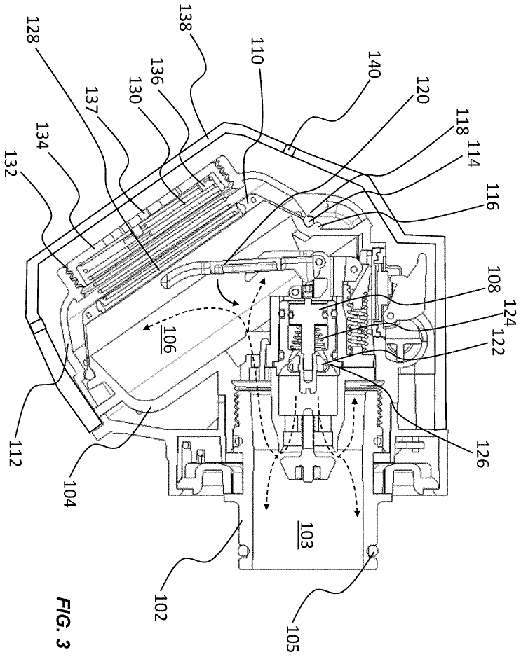

The demand regulator 100 is removably connected to the breathing mask 18. A connector conduit 102, shown in FIG. 3, projects from the demand regulator 100 and is configured to be received in a corresponding connector opening in the mask 18 (not shown). One or more latches or locks may be provided to secure the demand regulator 100 to the breathing mask 18. One or more buttons 107 may be provided on the demand regulator 100 to release the latches or locks to enable disconnection of the demand regulator 100 from the mask 18. In some examples, the demand regulator 100 may be locked in position entirely so that it cannot move relative to the mask 18 while the two are connected. In some examples, the demand regulator 100 may be able to freely rotate relative to the breathing mask 18, for example about a central axis of the connector conduit 102, while the two are connected.

Turning now to FIG. 3, the demand regulator 100 is shown in side-view cross section on the plane A-A shown in FIG. 2. Demand regulators are also sometimes known as “lung demand valves” or LDVs. The function of a demand regulator is to reduce the pressure (i.e., act as a second-stage pressure reducer) of the gas delivered from the breathing gas cylinder via the pneumatics system 20 and hose 22, and additionally meter the flow of breathing gas to the user wearing the breathing mask 18.

The demand regulator 100 comprises a housing 104 defining an internal chamber 106. The chamber 106 is for pressure sensing. The internal chamber 106 is in communication with a valve apparatus 108 for controlling flow of breathing gas into the internal passage 103 of the connector conduit 102. The valve apparatus 108 receives breathing gas from the hose 22 of the pneumatics system 20 and, when open, expands breathing gas (thereby acting as a second-stage pressure reducer) and expels it into the internal passage 103, which is also in communication with the internal chamber 106. Dashed line arrows in FIG. 3 show exemplary paths of gas when expelled from the valve apparatus 108. During use, the valve apparatus may be configured to provide ‘positive pressure’ (e.g., a pressure of 0-5 millibar above ambient pressure) in the internal chamber 106 and the internal conduit 103 and, consequently, the breathing mask 18. This may be achieved by setting the valve apparatus 108 in a slightly open position to flow gas continuously into the internal chamber 106 and maintain the pressure within the internal chamber 106, internal passage 103, and the breathing mask 18 above the ambient pressure, such that ambient gas may not ingress into the mask 18.

The demand regulator 100 comprises a connector conduit 102 which extends from the housing 104 and defines an internal passage 103 through which breathing gas can pass to the breathing mask 18, when the connector conduit 102 is received within the connector opening in the mask 18. The internal passage 103 is in fluid communication with the internal chamber 106. The connector conduit 102 and the passage 103 may both be substantially cylindrical. An outer surface of the connector conduit 102 comprises an annular sealing element 105 for sealing with the connector opening in the mask 18. It should be understood that, as the passage 103 is in communication with the mask 18, when the user inhales, the pressure in the passage 103 and in the internal chamber 106 are reduced.

The demand regulator 100 further comprises a diaphragm apparatus 110. The diaphragm apparatus 110 may consist of a single layer, component or material or may comprise a plurality of layers, components, and/or materials. The diaphragm apparatus 110 may be substantially circular in plan. The diaphragm apparatus 110 is arranged to form a barrier between the internal chamber 106 and the ambient environment. In other words, a first side of the diaphragm apparatus 110 is exposed to the ambient environment (and the ambient pressure) and a second side of the diaphragm apparatus 110 is exposed to the internal chamber 106 (and the chamber pressure therein). The diaphragm apparatus 110 is sealed about its periphery and comprises elastically deformable material, such that a pressure differential between the ambient pressure and chamber pressure will cause the diaphragm apparatus to move towards the internal chamber 106 in response to a pressure reduction within the internal chamber 106, and away from the internal chamber 106 in response to a pressure increase in the internal chamber 106. It will be understood that, the diaphragm apparatus 110 is configured to move towards the internal chamber in response to a user inhaling and thereby reducing the pressure in the internal chamber, creating an increased pressure differential across the diaphragm apparatus 110.

The diaphragm apparatus 110 may be removable, for example for cleaning or replacement. The demand regulator 100 further comprises a diaphragm cap 112 configured to substantially overlay the diaphragm apparatus 110 and the housing 104. The diaphragm cap 112 is configured to secure the diaphragm apparatus 110 between the diaphragm cap 112 and the housing 104. To achieve this, the diaphragm apparatus 110 comprises a peripheral sealing bead 114, the housing 104 comprises a first annular sealing seat 116, and the diaphragm cap comprises a second annular sealing seat 118. The diaphragm cap 112 is secured to the housing 104, for example by a screw thread, with the sealing bead 114 arranged therebetween, so as to compress or secure the sealing bead 114 of the diaphragm apparatus 110 between the first and second sealing seats 116, 118 and thereby secure and seal the diaphragm apparatus 110.

Turning now to the operation of the valve apparatus 108, the valve apparatus comprises a valve actuator 120 for actuating the valve apparatus 108. In this example, the valve actuator 120 takes the form of an actuator lever 120. The actuator lever 120 is pivotally connected to the housing 104 and to a valve member 122 of the valve apparatus 108. Pivoting movement of the actuator lever 120 in an anticlockwise direction as shown in FIG. 3 by the solid arrow moves the valve member 122 away from a valve seat 126 of the valve apparatus 108, which in turn increases the flow of breathing gas permitted through the valve apparatus 108. A distal portion of the valve actuator level 120 contacts the diaphragm apparatus 110 such that movement of the diaphragm in turn moves the actuator lever 120 and actuates the valve. A valve spring 124 is provided to bias the valve member 122 towards the valve seat 126, (i.e. to bias the valve apparatus 108) towards a closed position.

The diaphragm apparatus 110 in this example comprises a contact pad 128 formed from a substantially rigid material. The contact pad 128 is configured to provide a more robust contact point between the valve actuator lever 120 and the diaphragm apparatus 110 to transfer forces therebetween. The actuator lever 120 may be biased, for example with a spring, in the clockwise direction as shown in FIG. 3 so as to maintain contact between the actuator lever 120 and the contact pad 128.

In this way, the diaphragm apparatus 110 is in operative connection with the valve apparatus 108. Movement of the diaphragm apparatus 110 towards the internal chamber 106 will in turn pivot the actuator lever 120 and increase the separation between the valve member 122 and valve seat 126, thereby increasing gas flow through the valve apparatus 108. It should be understood that when the forces (including pressure) which are applied to the diaphragm apparatus 110 and the valve apparatus 108 are in equilibrium, the valve member 122 will assume a balanced position. In some examples, for example where positive pressure is not required, this may be a fully closed position in which the valve member 122 is sealed against the valve seat 126. In other examples, such as where positive pressure is required in the mask 18, this may be a slightly open position which allows some flow through the valve. The demand regulator 100 may further comprise a lock-out mechanism which mechanically forces the valve apparatus 108 into a fully closed position regardless of the other forces being applied, which may be activated when the demand regulator is not in use, for example.

The demand regulator 100 further comprises a diaphragm biasing spring 130. The diaphragm biasing spring 130 is configured to apply a biasing force to the diaphragm apparatus 110 towards the internal chamber 106. In this example, the diaphragm biasing spring 130 is a helical spring which is compressed between the diaphragm apparatus 110 and the diaphragm cap 112, such that it applies a pushing force to the diaphragm apparatus 110. It should be understood that other arrangements are possible, for example, the diaphragm biasing spring may be configured to apply a pulling force to the diaphragm apparatus and/or a different type of spring or biasing member could be utilised. The diaphragm cap 112 comprises a spring seat cap 134 which forms a spring seat 136 for one end of the diaphragm biasing spring 130. The other end of the diaphragm biasing spring 130 contacts the contact pad 128 of the diaphragm apparatus 110. Consequently, the diaphragm biasing spring 130 is compressed between the spring seat cap 134 and the diaphragm apparatus 110 to apply the biasing force to the diaphragm apparatus 110.

It should be understood that there are various forces being applied to the diaphragm apparatus 110 and the valve apparatus 108 which will affect the balance or equilibrium position of these components. For example, if positive pressure is required, then the balancing of the various forces may be of significant importance to ensure that the correct gas flow is permitted through the valve apparatus 108. In addition, calibration of the demand regulator components is also of importance to tune the magnitude of force required to move the diaphragm apparatus 110 to enable the user to breathe freely without excessive inhalation effort.

To adjust the biasing force and, consequently, the balancing of the demand regulator 100, the demand regulator 100 further comprises a bias adjustment apparatus 132 which is configured to adjust compression of the diaphragm biasing spring 130 and thereby to adjust the biasing force applied to the diaphragm apparatus 110. The bias adjustment apparatus 132 is configured to adjust a spacing between the spring seat 136 and the diaphragm apparatus 110 so as to adjust the compression or deformation of the diaphragm biasing spring 130. As the spring seat 136 is provided on the spring seat cap 134, the spring seat cap 134 is configured to be so as adjust the spacing between the spring seat 136 and the diaphragm apparatus 110. The spring seat cap 134 is configured to substantially overlay the first side of the diaphragm apparatus 110. In addition, the spring seat cap 134 comprises one or more apertures 137 therethrough to permit fluid communication between the first side of the diaphragm apparatus 110 and the ambient environment.

In this example, reducing the spacing between the spring seat 136 and the diaphragm apparatus 110 increases the biasing force. Likewise, increasing the spacing between the spring seat 136 and the diaphragm apparatus 110 decreases the biasing force. In this example, movement of the spring seat 136 is achieved by providing the spring seat cap 134 in an opening in the diaphragm cap 112, connected via a helical thread on the periphery of the spring seat cap 134 and a corresponding thread on the internal wall of the opening in the diaphragm cap 112. Consequently, the position of the spring seat cap 134 can be adjusted relative to the diaphragm cap 112 by rotating the spring seat cap 134. It should be understood that rotating the spring seat cap 134 thereby adjusts the spacing between the spring seat 136 and the and the diaphragm apparatus 110. In this example, clockwise rotation of the spring seat cap 134 decreases the spacing and increases the biasing force, while anti-clockwise rotation of the spring seat cap 134 increases the spacing and reduces the biasing force.

It should be understood that adjusting this spacing and, consequently, the biasing force adjusts the resting position of the diaphragm apparatus 110, which in turn adjusts a resting position or balance of the valve apparatus 108. As should be appreciated, adjusting the resting position of the valve apparatus 108 may adjust a minimum flow rate of the valve apparatus 108 or the inhalation effort required by the user to move the diaphragm apparatus 110. More generally, reducing the biasing force may increase the pressure differential required across the diaphragm apparatus 110 to move the diaphragm apparatus 110, while increasing the biasing force may decrease the pressure differential required across the diaphragm apparatus 110 to move the diaphragm apparatus. Providing a bias adjustment apparatus 132 enables the biasing force to be adjusted to thereby adjust the balance or equilibrium position of the diaphragm apparatus 110 and the valve apparatus 108.

In this example, the diaphragm biasing spring is a helical spring and the spring seat cap 134 and the spring seat 136 are substantially circular in plan view. In this way, the spring seat cap 134 can be rotated easily while in contact with the biasing spring 130 without damaging the biasing spring 130.

In some examples, the bias adjustment apparatus 132 may further comprise a locking feature configured to lock the bias adjustment apparatus 132 so as to prevent adjustment of the spacing between the spring seat 136 and the diaphragm apparatus 110. Therefore, once the bias adjustment apparatus 132 has been calibrated to provide the required balance for the demand regulator 100, the locking feature can be engaged to prevent accidental or deliberate tampering which might affect the calibration of the demand regulator 100. In some examples, the locking mechanism may take the form of a grub screw, a detent mechanism, or some other feature which prevents adjustment of the bias adjustment apparatus 132. In some examples, once the bias adjustment apparatus 132 has been adjusted to the appropriate position, it may be permanently secured, for example by gluing or welding.

In addition, the demand regulator 100 in this example further comprises a dust shield 138, which is removable. The dust shield is elastomeric and is configured to overlay the diaphragm apparatus 110, the diaphragm cap 112, and much of the housing 104 so as to protect the demand regulator and, in particular, the first side of the diaphragm apparatus 110. The dust shield 138 comprises apertures 140 for permitting fluid communication between the ambient environment and the first side of the diaphragm apparatus 110.

The demand regulator 100 of the present disclosure may provide easier calibration of the demand regulator. As the bias adjustment apparatus is adjustable via the exterior of the demand regulator housing 104, the calibration of the demand regulator 100 can be adjusted without requiring significant disassembly of the regulator 100.

It should be appreciated that the exemplary arrangement disclosed is one of many possible configurations for providing a biasing force to the diaphragm 110. Where another biasing configuration is used, it should be understood that the principles of the present disclosure could be applied and adapted to provide a bias adjustment mechanism which is suitable for adjusting the biasing force applied to the diaphragm 110.

1. A demand regulator for a breathing apparatus comprising:
a housing defining an internal chamber;
a valve apparatus for controlling flow of breathing gas into the internal chamber;
a diaphragm apparatus having a first side configured to be exposed to an ambient environment and a second side configured to be exposed to the internal chamber, the diaphragm apparatus being in operative connection with the valve apparatus;
a diaphragm biasing spring configured to apply a biasing force to the diaphragm apparatus; and
a bias adjustment apparatus configured to adjust compression or deformation of the diaphragm biasing spring so as to adjust the biasing force applied to the diaphragm apparatus.

2. A demand regulator according to claim 1, wherein the diaphragm biasing spring is configured to apply the biasing force on the diaphragm towards the internal chamber.

3. A demand regulator as claimed in claim 1, wherein the diaphragm biasing spring is configured to contact the diaphragm apparatus and contact a spring seat of the demand regulator so as to be compressed or deformed between the diaphragm apparatus and the spring seat to apply the biasing force.

4. A demand regulator as claimed in claim 3, wherein the bias adjustment apparatus is configured to adjust a spacing between the spring seat and the diaphragm apparatus so as to adjust the compression or deformation of the diaphragm biasing spring.

5. A demand regulator as claimed in claim 4, wherein the spring seat is moveable so as to adjust the spacing between the spring seat and the diaphragm apparatus.

6. A demand regulator as claimed in claim 5, wherein the spring seat is provided on a spring seat cap configured to substantially overlay the first side of the diaphragm apparatus.

7. A demand regulator as claimed in claim 6, wherein the spring seat cap comprises a helical thread and the demand regulator further comprises a corresponding thread, the threads being configured to adjust a position of the spring seat cap relative to the diaphragm apparatus so as to adjust the spacing between the spring seat and the diaphragm apparatus.

8. A demand regulator as claimed in claim 6, wherein the diaphragm biasing spring is a helical spring and wherein the spring seat cap is substantially circular in plan view.

9. A demand regulator as claimed in claim 4, wherein the bias adjustment apparatus further comprises a locking feature configured to lock the bias adjustment apparatus so as to prevent adjustment of the spacing between the spring seat and the diaphragm apparatus.

10. A demand regulator as claimed in claim 1, wherein the demand regulator further comprises a diaphragm cap configured to substantially overlay the diaphragm apparatus.

11. A demand regulator as claimed in claim 10, wherein the diaphragm cap comprises the spring seat cap, and wherein the relative position of the spring seat cap and the diaphragm cap is adjustable.

12. A demand regulator as claimed in claim 1, further comprising a removable dust shield configured to overlay the diaphragm apparatus so as to protect the first side of the diaphragm apparatus, the removable dust shield comprising one or more apertures for permitting fluid communication between the ambient environment and the first side of the diaphragm apparatus.

13. A breathing mask for a breathing apparatus comprising the demand regulator of claim 1.

14. A breathing apparatus comprising the demand regulator of claim 1.

15. A breathing apparatus comprising the breathing mask of claim 13.

16. A demand regulator as claimed in claim 6, wherein the spring seat cap comprises one or more apertures therethrough

17. A demand regulator as claimed in claim 10, wherein the diaphragm cap is configured to secure the diaphragm between the diaphragm cap and the housing.
